(19) United States
(12) Patent Application Publication
(10) Pub. No.: US 2013/0073773 A1
(43) Pub. Date: Mar. 21, 2013

(54) ACCESS CONTROL APPARATUS, IMAGE FORMING APPARATUS, AND ACCESS CONTROL METHOD

(71) Applicant: Yuuji MATSUDA, Tokyo (JP)

(72) Inventor: Yuuji MATSUDA, Tokyo (JP)

(21) Appl. No.: 13/614,105

(22) Filed: Sep. 13, 2012

(30) Foreign Application Priority Data
Sep. 15, 2011 (JP) 2011-201773

(51) Int. Cl. G06F 13/36

(52) U.S. Cl. 710/309

(57) ABSTRACT

An access control apparatus includes an external bus control unit that controls an external bus for transmitting and receiving data to and from an external device. The external bus control unit includes: a plurality of storage units disposed corresponding to the external device for temporarily storing data from an internal bus; and an arbitration unit that selects a storage unit for transferring data to the external bus from the plurality of storage units in response to an access request from the internal bus and outputs the data stored in the selected storage unit to the external bus.

### CROSS-REFERENCE TO RELATED APPLICATIONS

The present application claims priority to and incorporates by reference the entire contents of Japanese Patent Application No. 2011-201773 filed in Japan on Sep. 15, 2011.

### BACKGROUND OF THE INVENTION

1. Field of the Invention

The invention relates to an access control apparatus, an image forming apparatus, and access control method.

2. Description of the Related Art

An electrophotography image forming apparatus is composed of a controller circuit for integrally controlling the apparatus in its entirety, an operating unit circuit connected to the controller circuit, a LAN interface circuit, an engine control circuit for performing an image forming and paper feed/discharge control, a scanner control circuit for scanning a document, and an LDB (Laser Diode board) circuit for writing image data obtained by scanning the document on a photosensitive drum.

Among the components, the controller circuit for integrally controlling the apparatus in its entirety is mounted with a CPU (Central Processing Unit) and controls respective control circuits by operating a program using non-volatile memory for storing the program and volatile memory for storing temporal job data.

In general, a CPU has a DMA (Direct Memory Access) controller on the same bus and controls respective devices connected to the outside via an external bus controller disposed on the same bus likewise and the DMA is often composed of an ASIC (Application Specific Integrated Circuit).

At the time, to minimize a number of pins of the ASIC, a configuration is employed in which external buses are not prepared as many as devices connected thereto, the devices are connected in parallel, and a device to be accessed is specified using a device selection signal.

Ordinarily, although a bus in an ASIC can be accessed at a high speed such as one cycle, although this depends on a cycle frequency, in an access to an external bus, a signal is delayed due to a terminal capacity of the ASIC, a path of a substrate and a harness, and a buffer. Accordingly, when the external bus is accessed, the external bus is accessed at a speed at which an external device can respond to the access. When the internal bus is also accessed in accordance with the access speed of the external device, however, since a process performance of the internal bus is lowered, ordinarily, a configuration for absorbing a speed difference therebetween using a FiFo (First-In First-Out) memory is employed. With the configuration described above, as long as the FiFo memory has an empty space, it can be avoided that the internal bus is waited.

Further, recently, an internal bus may be configured in a matrix state. There is already known a technology capable of transferring data at the same time when a CPU and a DMA controller which are connected on the same bus have a different access source and a different access destination by configuring an internal bus as described above.

Further, Japanese Patent Application Laid-open No. H11-085670 A discloses a technology in which a DMAC is disposed in front of a bus controller built in a microcomputer and no data buffer is disposed to the DMAC, and when a data transfer control is performed by the DMAC, data is directly transferred from a data buffer of the bus controller to a transfer destination for the purpose of reducing a number of operation cycles necessary to a data transfer by the DMAC.

However, in the configurations of the conventional technologies, an access cycle from an external bus to a FiFo memory is slower than an access cycle from an internal bus to the FiFo memory. Thus, no problem occurs when the FiFo memory has an empty space, whereas when an access is frequently performed to the external bus, a problem arises in that the FiFo memory frequently becomes FULL. When the FiFo memory becomes FULL, since data cannot be written from the internal bus, the internal bus may be waited until the internal bus is permitted to write data, from which a problem arises in that an access performance of the internal bus is lowered due to the access speed of the external bus.

Further, when an external bus controller is connected to an internal bus via one system, a problem arises in that an access cannot be performed from plural modules at the same time. When, for example, access requests to an external bus are generated from a CPU and a DMA controller at the same time, ordinarily, an access having a high priority order is processed preferentially. In the case, an access having a low priority order is waited until a process of the access having the high priority order is finished. When accesses are performed to the same external bus space, although it cannot be avoided that an access having a low priority order is waited, when accesses are performed to different external bus spaces, an internal bus must be avoided from being waited.

Further, there is also a problem that when an access request having a high priority order is a burst write access request, an access request having a low priority order is waited until the burst write access is finished.

To solve the problem, there can be considered a configuration in which plural FiFo memories are provided and each of the FiFo memories is connected to an internal bus. As an advantage of the configuration, even if accesses to the different external bus spaces occur, a waited state of the internal bus can be avoided because a FiFo memory is different.

However, in the conventional technologies, since the external bus has only one input/output system, when a burst write operation starts in the internal bus in a control according to an access order, a problem arises in that an access to the external bus is also occupied by a burst operation and an access request from other bus is waited.

Therefore, there is a need to provide an access control apparatus, an image forming apparatus, and an access control method capable of reducing a frequency at which an internal bus is waited when write accesses are performed from plural internal modules to different external bus spaces at the same time and improving a performance of the internal bus.

### SUMMARY OF THE INVENTION

It is an object of the present invention to at least partially solve the problems in the conventional technology.

According to an aspect of the present invention, there is provided an access control apparatus including: an external bus control unit that controls an external bus for transmitting and receiving data to and from an external device, wherein the external bus control unit includes: a plurality of storage units disposed corresponding to the external device for temporarily storing data from an internal bus; and an arbitration unit that selects a storage unit for transferring data to the external bus from the plurality of storage units in response to an access request from the internal bus and outputs the data stored in the selected storage unit to the external bus.

According to another aspect of the present invention, there is provided an image forming apparatus including a control unit that performs control as to an image formation, wherein: the control unit includes an external bus control unit that controls an external bus for transmitting and receiving data to and from an external device that is a device externally of the control unit; and the external bus control unit includes: a plurality of storage units disposed corresponding to the external device for temporarily storing data from the internal bus; and an arbitration unit that performs control for changing an order in which data of each of the plurality of storage units is output to the external bus each time an access is performed from the internal bus and outputs data of each of the plurality of storage units to the external bus in the changed order.

According to still another aspect of the present invention, there is provided an access control method performed in an access control apparatus, wherein: the access control apparatus includes an external bus control unit that controls an external bus for transmitting and receiving data to and from an external device; and the external bus control unit comprises a plurality of storage units disposed corresponding to the external device for temporarily storing data from an internal bus, and the access control method including: performing control for changing an order in which data of each of the plurality of storage units is output to the external bus each time an access is performed from the internal bus; and outputting data of each of the plurality of storage units to the external bus in the changed order.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration of an electric system of an image forming apparatus according to a first embodiment;

FIG. 2 is a configuration view of an ASIC;

FIG. 3 is an explanatory view illustrating external bus address spaces and an allocation of FiFo memories;

FIGS. 4A and 4B are explanatory views illustrating operation timings of an external bus controller of the first embodiment;

FIGS. 5A and 5B are explanatory views illustrating operation timings of an external bus controller of a second embodiment;

FIGS. 6A and 6B are explanatory views illustrating operation timings of an external bus controller of a third embodiment;

FIGS. 7A, 7B and 7C are explanatory views illustrating operation timings of a conventional external bus controller;

FIG. 8 is a configuration view of a conventional external bus controller provided with no FiFo memory; and

FIG. 9 is a configuration view of an external bus controller of a conventional example provided with a FiFo memory.

### DETAILED DESCRIPTION OF THE PREFERRED EMBODIMENTS

Embodiments of an access control apparatus, an image forming apparatus, and an access control method will be explained below in detail referring to the attached drawings.

### First Embodiment

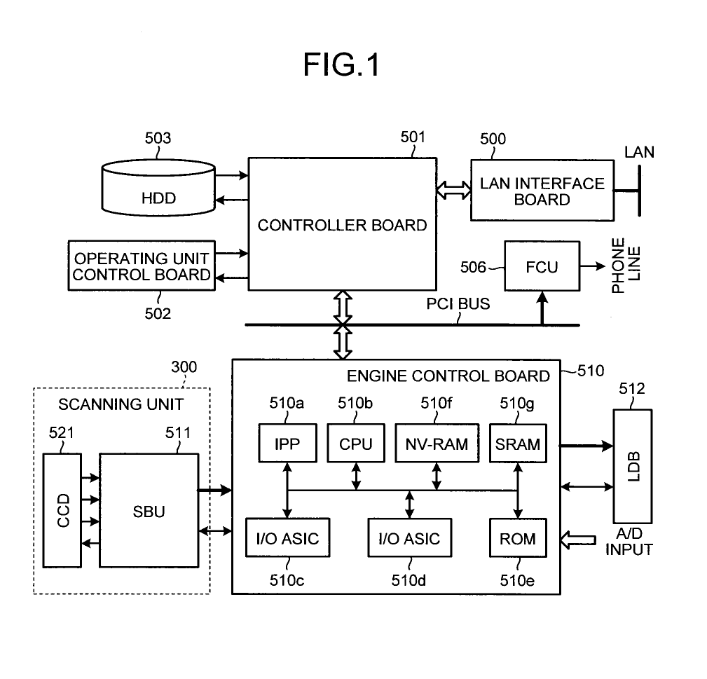

FIG. 1 is a block diagram illustrating a configuration of an electric system of an image forming apparatus according to a first embodiment. The embodiment will be explained exemplifying an MFP having a copy function, a scanner function, a facsimile function, and a printer function as an image forming apparatus. Note that the invention can be applied to any of image forming apparatuses such as a copy machine, a printer, a scanner apparatus, and a facsimile apparatus.

As illustrated in FIG. 1, the image forming apparatus of the embodiment mainly includes a controller board 501, an operating unit control board 502, an HDD (Hard Disk Drive) 503, a LAN interface board 500, a FAX control unit (FCU) 506 connected to a general purpose PCI bus, an engine control board 510, a scanning unit 300, and an LDB (Laser Diode control Board) 512. The image forming apparatus includes also an IEEE1394 board, a wireless LAN board, and a USB board (any of which is not illustrated) in addition to the above components.

The LAN interface board 500 is connected to a company LAN and acts as a communication interface board between the company LAN and the controller board 501. A communication to external equipment is performed via the LAN interface board 500.

The HDD 503 is a storage medium for storing various data such as image data. More specifically, the HDD 503 is used as an application database, which stores an application program of the image forming apparatus and stores equipment urging information of a printer and an image forming process equipment, and as an image database which accumulates image data of a scanned image and written image, and document data.

The operating unit control board 502 is connected to the controller board 501 and controls an operation display unit (not illustrated) for displaying various screens to a user and receiving an input from the user. The FCU 506 is a unit that realizes the facsimile function.

The engine control board 510 is connected to the controller board 501 via a PCI bus and controls the LDB 512 that is the engine and the scanning unit 300. That is, the engine control board 510 mainly performs image forming control of the image forming apparatus and includes a CPU 510b, an image data processor (IPP: the image processing Processor) 510a for performing image processing, a ROM 510e stored with a program necessary to control a copy and a print-out, an SRAM 510g necessary to control the ROM 510e, and an NV-RAM 510f for storing various parameters necessary to form an image and further includes plural I/O ASICs 510c and 510d for controlling I/Os (counter, fan, solenoid, and motor), and these devices are connected to each other via an external bus, respectively. The CPU 510b reads data stored in the ROM 510e and forms an image by controlling the respective devices according to a program code.

The scanning unit 300 includes a CCD 521 and a scanner board unit (SBU: Scanner Board Unit) 511. The CCD 521 scans an illumination light source to a document to be copied, optically scans the document and focuses reflected light of light radiated onto the document, and creates an image signal by photoelectrically converting the reflected light.

The SBU 511 includes an analog ASIC and the CCD 521, and a circuit (not illustrated) for generating drive timing of the analog ASIC. The image signal output from the CCD 521 is converted to digital image data in the analog ASIC, subjected to a shading correction and the like, and sent to the IPP 510a of the engine control board 510.

The IPP 510a is a programmable arithmetic processing unit that performs the image processing and performs gradation processing and the like. The image data transferred from the SBU 511 to the IPP 510a is written to a not illustrated frame memory after a signal deterioration of the image data, which is caused by that the image data is quantized to an optical system and to a digital signal by the IPP 510a (signal deterioration of scanner system), is corrected.

The LDB 512 writes the image data obtained by scanning the document and image data received via a network to a photosensitive drum (not illustrated).

That is, the image data processed by the IPP 510a is stored once in a work memory of the controller board 501 via the PCI bus. The image data is read out from the work memory according to paper feed timing of a sheet and is input to an LD writing circuit of the LDB 512. The LD writing circuit performs LD current control (modulation control) of the image data which is output to respective LDs.

The controller board 501 is mounted with a CPU, ROM for storing a program, RAM that is work memory of the CPU, an ASIC for controlling a periphery of the CPU, and an interface circuit of the ASIC, any of which is not illustrated.

The controller board 501 has functions of plural applications such as a scanner application, a facsimile application, a printer application, and a copy application and controls the image forming apparatus in its entirety. Further, the controller board 501 reads an input of the operating unit control board 502 and displays setting of the system and contents of the settings on a liquid crystal panel of the operation display unit.

The PCI bus is connected to other unit and transferred with image data and a control command via an image data bus/control command bus in a time-division mode.

In the embodiment, IPP and I/O control for performing the image processing control is performed by hardware by the ASIC, and access control is performed to the respective devices only at the beginning of image formation or only when the I/O is operated. Accordingly, as an access frequency to the CPU, although a FROM and the RAM, which is used as a work area, are accessed at a high frequency, an access frequency to other devices is not so high as the FROM and the RAM. As described above, the access control apparatus has a configuration in which devices having a high access frequency and devices having a low access frequency mixedly exist.

However, when a number of registers set to an external device is increased, timing at which an access is performed to the external device may be overlapped with timing at which an access is performed to the FROM and the RAM at the beginning of image formation and at the time the I/O control is started. At the time, as to the access to the external device, since the same external buses connected in parallel are used due to a problem of a wiring region and a number of pins of the ASIC, a delay may occur to an access to respective devices. Even if the delay occurs, there is not a problem when an image creating operation is not adversely affected thereby as a result. However, in an image forming apparatus of type having a lot of data to be treated, having a fast copy speed, or having many inputs and outputs (many number of I/Os), an output image is adversely affected because, for example, that timing at which an image is created is not matched with timing at which a sheet is fed and sheets may be jammed because timings at which respective inputs/outputs are controlled are not matched. When a time during which a process accessing to an internal bus of the CPU at a high frequency is in wait state becomes a longer, particularly at timing of concentrated access to the external bus, a risk of occurrence of the problem described above is increased. Accordingly, in the embodiment, the ASIC is configured as described below.

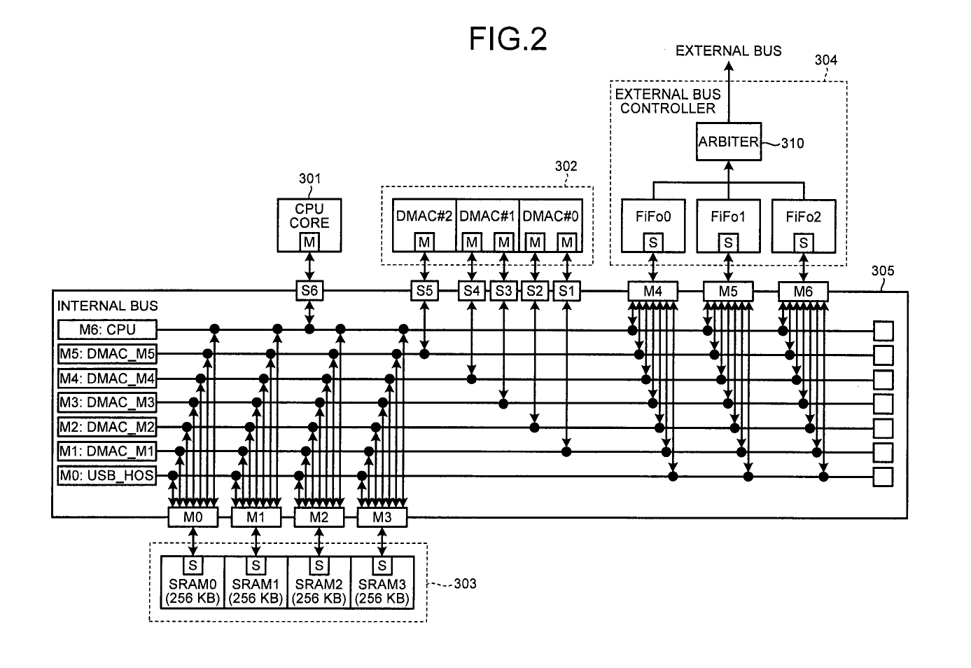

FIG. 2 is a configuration view of the ASIC. As illustrated in FIG. 2, the ASIC mainly includes a CPU core 301, DMA controllers 302, an internal SRAM 303, and an external bus controller 304 therein. Further, the ASIC includes also other modules such as a not illustrated UART/I2C/watchdog timer and the like. The modules are connected to each other via an internal bus 305 and transfer data between the modules using the CPU core 301 and the DMA controllers 302 as a master.

The internal bus 305 is formed in a matrix state so that data of modules that become bus masters can be exclusively transferred. Accordingly, it becomes possible to access other module (for example, UART) by the CPU core 301 and to transfer data from the SRAM 303 to an I2C module by the DMA controller 302 at the same time.

Note that, in the embodiment, the CPU core 301, the DMA 302, and a not illustrated USB-HOST are used as bus masters.

The SRAM 303 is disposed by being divided to plural regions. With the configuration, since the SRAM regions can be accessed from different masters at the same time, an efficiency of use of memories is improved.

An access to the external bus is performed via the external bus controller 304. In the embodiment, the external bus controller 304 is built-in with three first-in/first-out FiFo memories 0 to 2 (hereinafter, may be simply called “FiFo memories 0 to 2”) and an arbiter 310.

Each of the FiFo memories 0 to 2 is connected to the internal bus 305 and temporarily stores data transferred from the respective masters of the internal bus 305. In the embodiment, an external address space is allocated to each device (to each chip selection space).

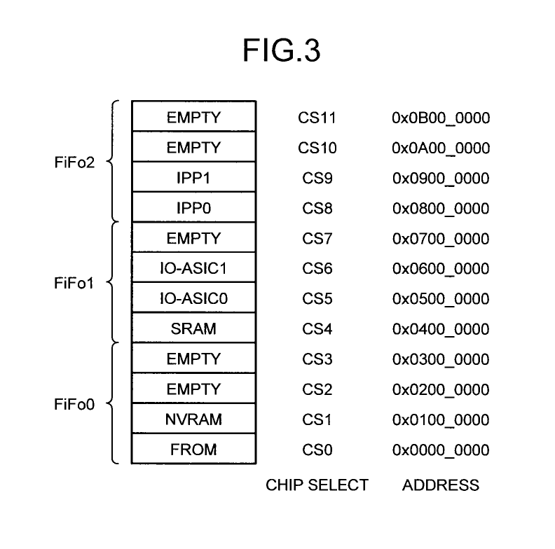

FIG. 3 is an explanatory view illustrating external bus address spaces and an allocation of the FiFo memories. As illustrated in FIG. 3, chip select spaces CS0 to CS3 that are external address spaces are allocated to the FiFo memory 0, chip select spaces CS4 to CS7 are allocated to the FiFo 1, and chip select spaces CS8 to CS11 are allocated to the FiFo 2. When not illustrated address decoders of the FiFo 0 to 2 access target address spaces according to an access space of the internal bus 305, the address decoders perform operations for storing addresses and data to the FiFo 0 to 2.

The data stored in the FiFo 0 to 2 are transferred to the external bus via the arbiter 310. The arbiter 310 mainly selects a FiFo that transfers data to the external bus from the FiFo 0 to 2. An operation of the arbiter 310 will be described later in detail.

As described above, since the external bus is connected with the plural external devices in parallel, the arbiter 310 also creates a chip selection signal (CS signal) for identifying that data being accessed transfers data of which of the external devices. In the embodiment, twelve CS spaces are provided, and each of the FiFo 0 to 2 stores access data of each four CS spaces.

Ordinarily, although a fast access of one cycle and the like is possible in an access to the internal bus although this depends on a cycle frequency, in an access to the external bus, a signal is delayed due to a terminal capacity of the ASIC, a path of a substrate and a harness, and a buffer. Accordingly, when the access is performed to the external bus, the access is performed at a speed at which an external device can respond to the access.

However, when the internal bus is accessed according to the access speed of the external device, a process performance of the internal bus is deteriorated. The FiFo 0 to 2 also have a role for absorbing a difference between the access speeds. With the configure, even if the external device is accessed slowly, the internal bus is avoided from being waited as long as the FiFo 0 to 2 have spaces.

Before an operation of the external bus controller 304 of the embodiment is explained, a conventional external bus controller will be explained.

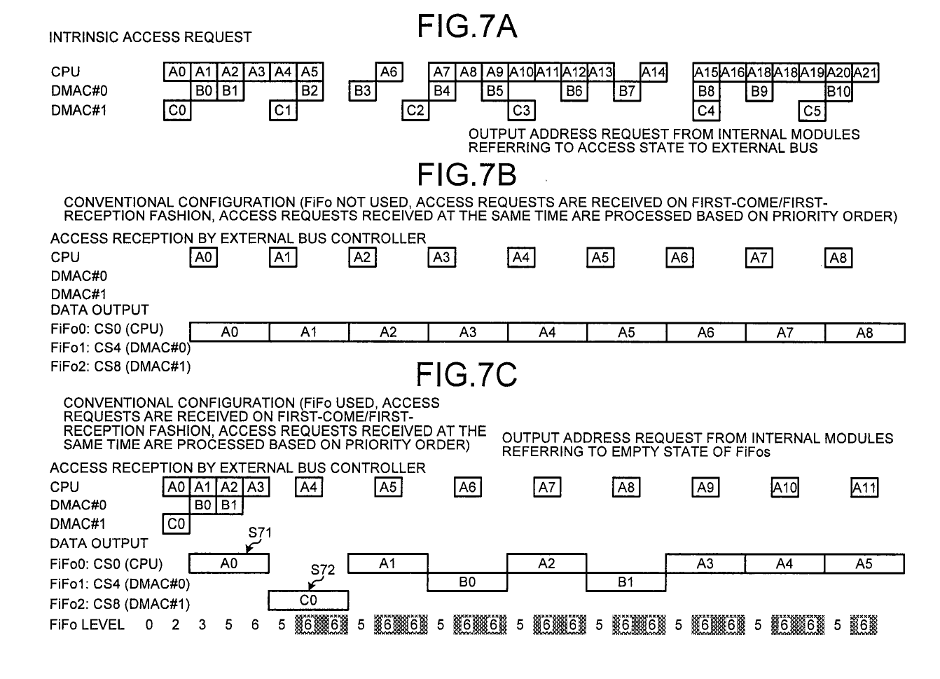

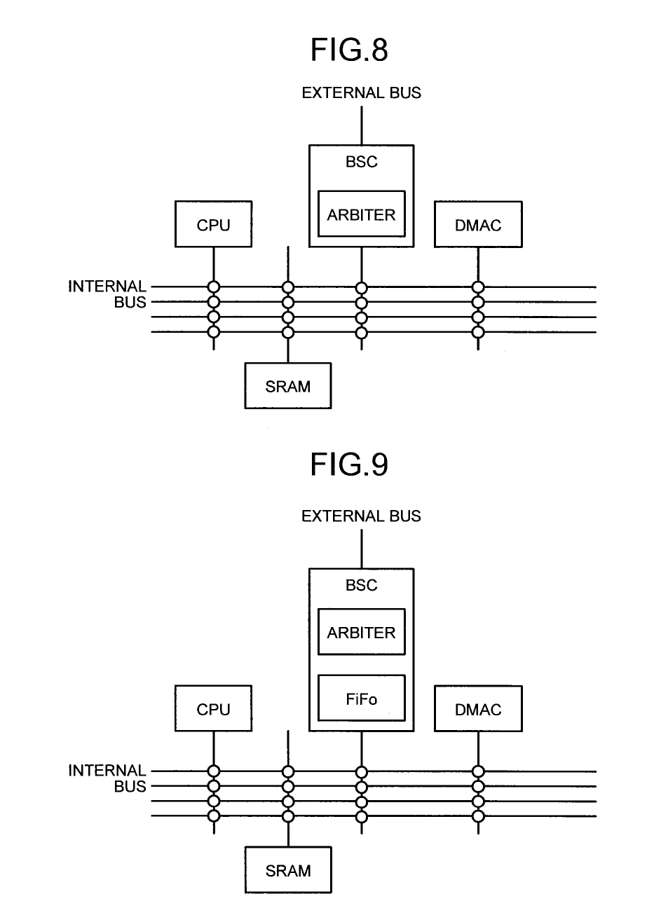

FIGS. 7A, 7B, and 7C are explanatory views illustrating operation timing of the conventional external bus controller. FIG. 7A illustrates access request timings from the respective modules, and FIG. 7B illustrates access timings when an internal bus is connected by one system and no FiFo memories is provided. FIG. 8 is a configuration view of a conventional external bus controller when no FiFo memory is provided.

When accesses via the internal bus are requested from the respective modules, the conventional external bus controller performs a process for receiving a process to which an access is requested earlier as needed. When plural requests are generated at the same time, a process having a higher priority order is processed earlier.

FIGS. 7A, 7B, and 7C illustrate examples in which a priority order is set to CPU>DMAC #0>DMAC #1, and, as illustrated in, for example, FIG. 7A, when plural requests such as “A0” and “C0” are generated at the same time, the request “A0” having a higher priority order is processed earlier as illustrated in FIG. 7B. When no FiFo memory is provided, since an access request having a high priority order is processed referred to an access request at the time the external access is finished, when access requests having a high priority order (CPU) are continuously generated as illustrated in FIGS. 7A, 7B, and 7C, a process of access requests having a low priority order (DMAC #0 and DMAC #1) is waited.

After the access requests having the high priority order have been briefly finished, the access having the low priority order is processed. Accordingly, a process having a high access frequency cannot help being set to a low priority order and a process having a low access frequency cannot help being set to a high priority order. Intrinsically, although it is desired to set an access from the CPU to a highest priority order, since an access having a high access frequency cannot help being set to a low priority order, a problem remains in that when processes are concentrated, a delay occurs.

FIG. 9 is a configuration view of an external bus controller of a conventional example when FiFo memories are interposed between internal buses and an arbiter.

FIG. 7C is a view illustrating access timings of an external bus controller (internal buses are connected by one system and FiFo memories are provided) of FIG. 9. Also in the example, it is assumed that accesses are requested from the respective modules at the timings illustrated in FIG. 7A. Further, in FIG. 7C, a FiFo level shows a state of a number of stages in which data are stored in the FiFo memories. In the example of FIG. 7C, since FiFo memories having six stages are used, when six data are stored in the FiFo memories, the FiFo memories become a state of FULL. In FIG. 7C, shaded portions of the FiFo level illustrate a state that FiFo memories become FULL.

As illustrated in FIG. 7C, when the FiFo memories are not in the state of FULL and have spaces, since data are stored in the FiFo memories on a first-come/first-stored fashion, the external bus can be accessed according to an access order of the internal buses (refer to S71 and S72). However, when access requests are concentrated and the FiFos become the state of FULL, since the same state as that of FIG. 7B also occurs and an access request having a high priority order is stored in the FiFo referring to access requests at the time the external access is finished, when access requests having a high priority order are continuously generated (in the examples of FIGS. 7A, 7B, and 7C, an access request from the CPU), a process of an access request having a low priority order (in the examples of FIGS. 7A, 7B, and 7C, access requests from DMAC #0 and DMAC #1) are waited. Although the problem can be solved by greatly increasing the number of stages of the FiFo memories, a manufacturing cost is increased.

Accordingly, the arbiter 310 of the embodiment selects a FiFo memory, which transfers data to the external bus, from the three FiFo memories 0 to 2 in response to an access request from an internal bus and outputs the data stored in the selected FiFo memory to the external bus. More specifically, a priority order of data output from the three FiFo memories 0 to 2 is determined first, the arbiter 310 changes the priority order of the data output from the three FiFo memories 0 to 2 in response to the access request from the internal bus, selects a FiFo memory for transferring data to the external bus according to the changed priority order, and outputs the data stored in the selected FiFo memory to the external bus.

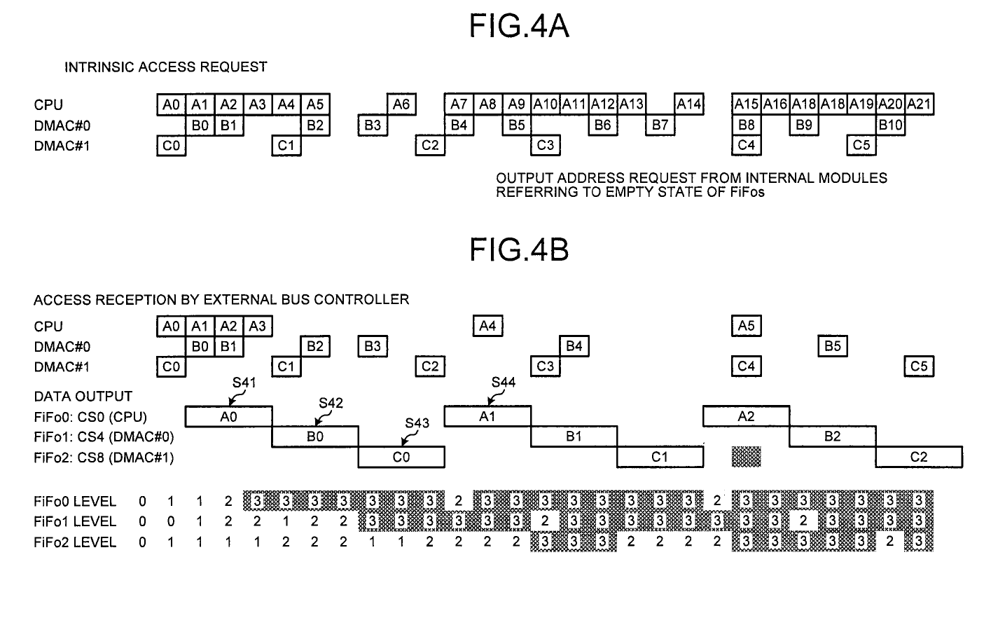

FIGS. 4A and 4B are explanatory views illustrating operation timings of the external bus controller of the first embodiment. FIG. 4A illustrates access request timings from the respective modules. FIG. 4B illustrates access timings when priority orders are interchanged between respective accesses by the arbiter 310 of the embodiment. FiFo levels illustrate states of a number of stages of the FiFo 0 to 2 in which data are stored. Since the FiFo 0 to 2 used in the example have three stages, the FiFo 0 to 2 become the state of FULL when the FiFo 0 to 2 store three data. FIG. 4B, shaded portions of the FiFo levels illustrate the state that the FiFo memories become FULL.

In the example of FIG. 4B, the external bus controller 304 receives access requests to A0 and C0 at the same time and stores A0 in the FiFo 0 and C0 in the FiFo 2. The external bus controller 304 outputs A0 to the external bus as data and then receives access requests to A1 and B0 at the same time and stores A1 in the FiFo 0 and B0 in the FiFo 1. Likewise, although the external bus controller 304 sequentially receives access requests and stores data in the FiFo 0 to 2, FIG. 4B illustrates that when the external bus controller 304 receives an access request to A3, the FiFo 0 becomes the state of FULL.

When data are stored in the FiFo memories, the arbiter 310 of the embodiment performs an operation for sequentially changing priority orders of data output from the FiFo memories 0 to 2 each time an access is performed.

For example, the priority order is first determined in a sequence of FiFo 0>FiFo 1>FiFo 2, and, at a first access, the arbiter 310 selects the FiFo memory 0 in the priority order of FiFo 0>FiFo 1>FiFo 2 and outputs the data stored in the FiFo memory 0 to the external bus. Accordingly, as illustrated in FIG. 4B, in the first access, “A0” stored in the FiFo 0 is output to the external bus (S41).

Further, in a second access, the arbiter 310 changes the priority order to a sequence of FiFo 1>FiFo 2>FiFo 0, selects the FiFo 1 according to the priority order, and outputs the data stored in the FiFo 1 to the external bus. Accordingly, as illustrated in FIG. 4B, in the second access, “B0” stored in the FiFo 1 is output to the external bus (S42).

Further, in a third access, the arbiter 310 changes the priority order to a sequence of FiFo 2>FiFo 0>FiFo 1, selects the FiFo 2, and outputs the data stored in the FiFo 2 to the external bus. Accordingly, as illustrated in FIG. 4B, in the third access, “C0” stored in the FiFo memory 2 is output to the external bus (S43).

Further, in a fourth access, the arbiter 310 changes the priority order to a sequence of FiFo 0>FiFo 1>FiFo 2, selects the FiFo 0, and outputs the data stored in the FiFo 0 to the external bus. Accordingly, as illustrated in FIG. 4B, in the fourth access, “A1” stored in the FiFo 0 is output to the external bus (S44).

Note that, when a FiFo memory in which no data is stored exists at the time, a lowest priority order is set to the FiFo memory.

When an access factor having a high priority order is a burst access request at the time a single FiFo memory is provided, other factor may be waited. However, in the embodiment, since the plural FiFo memories 0 to 2 are provided and the arbiter 310 changes the priority order in which data is transferred each time an access is performed, data of respective factors are transferred uniformly. Thus, according to the embodiment, a lock time of the internal buses can be shortened, and thereby a performance can be improved.

### Second Embodiment

In a second embodiment, control performed by an arbiter 310 is different from that of the first embodiment. A configuration of an electric system and a configuration of an ASIC of an image forming apparatus of the second embodiment are the same as those of the first embodiment explained using FIGS. 1 and 2.

In the embodiment, each of three FiFos 0 to 2 is previously set with a weighted value. The weighted values are preferably stored in ROM or RAM corresponding to the FiFos 0 to 2.

The arbiter 310 of the embodiment changes a priority order of the data output from the three FiFos 0 to 2 based on the weighted values in response to an access request from an internal bus 305. More specifically, when a FiFo memory has a larger weighted value, the arbiter 310 sets a larger access number of times to which a highest priority order of the FiFo memory is applied, and after the highest priority order is applied as many times as the access number of times, the arbiter 310 changes the priority order. Then the arbiter 310 selects a FiFo memory from which data is transferred to an external bus according to the changed priority order and outputs the data stored in the selected FiFo memory to the external bus.

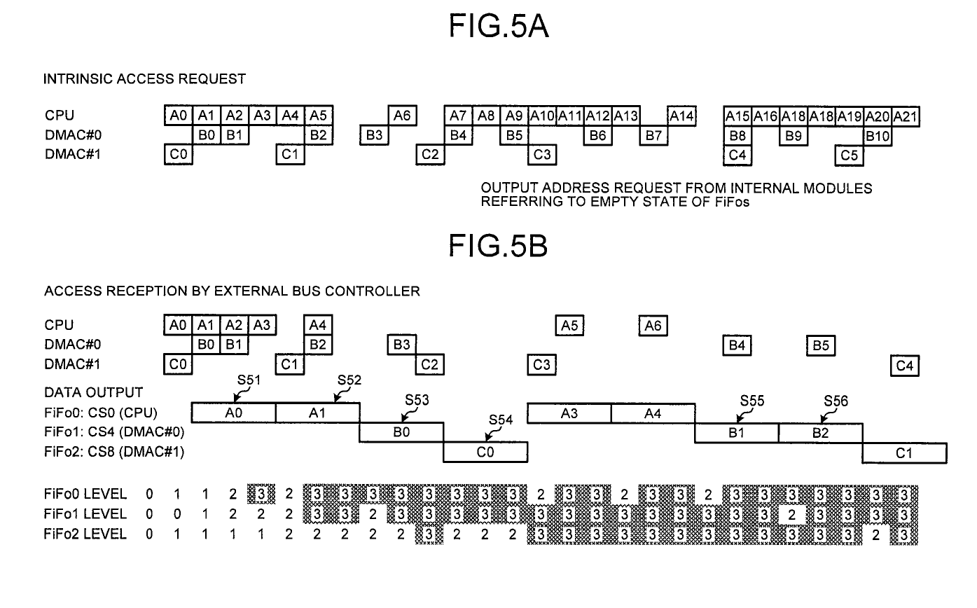

FIGS. 5A and 5B are an explanatory views illustrating operation timings of an external bus controller of the second embodiment. FIG. 5A illustrates access request timings from respective modules and is the same as FIG. 4A. FIG. 5B illustrates access timings when the arbiter 310 of the embodiment interchanges priority orders of respective accesses based on a weighted value. Also in the example, the FiFos 0 to 2 use three-stage memories, and shaded portions of FiFo levels illustrate a state that the FiFo become FULL.

In an example of FIG. 5B, the weighted value of the FiFo 0 is set to 2, the weighted value of the FiFo 1 is set to 1.5, and the weighted value of the FiFo 2 is set to 1. Note that the setting of the weighted values is not limited to the above one.

The priority order is specifically changed by the weighted values as described below. The arbiter 310 transfers data by continuously applying a highest priority order of the FiFo memory having the weighted value of 2 to an access performed twice and thereafter changes the priority order in a subsequent access.

Further, the arbiter 310 transfers data by applying a highest priority order of the FiFo memory having the weighted value of 1.5 at a first round once and thereafter changes the priority order in a subsequent access. Then, the arbiter 310 transfers data by applying the highest priority order of the FiFo memory having the weighted value of 1.5 at a second round twice and thereafter changes the priority order in a subsequent access.

Further, the arbiter 310 transfers data by applying a highest priority order of the FiFo memory having the weighted value of 1 once and thereafter changes the priority order in a subsequent access.

In the example of FIG. 5B, in a first access, the arbiter 310 selects the FiFo 0 according to a sequence of FiFo 0 having weighted value of 2 and highest priority order>FiFo 1>FiFo 2 and outputs the data stored in the selected FiFo 0 to the external bus (S51). Further, also in an access at a second round, the arbiter 310 selects the FiFo 0 according to FiFo 0 having weighted value of 2 and highest priority order>FiFo 1>FiFo 2 and outputs the data stored in the selected FiFo 0 to the external bus (S52).

Accordingly, as illustrated in FIG. 5B, “A0” stored in the FiFo 0 is output to the external bus in the first access, and “A1” stored in the FiFo 0 is output to the external bus in a second access.

In a third access (first round), the arbiter 310 selects the FiFo 1 according to a sequence of FiFo 1 having weighted value of 1.5 and highest priority order>FiFo 2>FiFo 0 and outputs the data stored in the selected FiFo 1 to the external bus (S53). Accordingly, as illustrated in FIG. 5B, in the third access, “B1” stored in the FiFo 1 is output to the external bus.

Note that, at the second round, after the arbiter 310 applies the FiFo 1 which has the weighted value of 1.5, the highest priority order, and the sequence of FiFo 1>FiFo 2>FiFo 0, to the access performed twice, the arbiter 310 changes the priority order (S55 and S56).

Further, in a fourth access, the arbiter 310 selects the FiFo 2 having the weighted value of 1.5 and the highest priority order according to a sequence of FiFo 2>FiFo 0>FiFo 1 and outputs the data stored in the selected FiFo 2 to the external bus (S54). Accordingly, as illustrated in FIG. 5B, in the fourth access, “B0” stored in the FiFo 2 is output to the external bus.

As described above, the arbiter 310 of the embodiment performs an operation in which the priority order changes according to the weights of the FiFo 0 to 2. Accordingly, when a large value is previously set to a FiFo having a high access frequency as the weighted value, since an access to the FiFo can be preferentially performed, an internal bus lock time of a bus master having a high frequency can be shortened.

### Third Embodiment

Also in a third embodiment, control performed by the arbiter 310 is different from that of the first embodiment. A configuration of an electric system and a configuration of an ASIC of an image forming apparatus of the third embodiment are the same as those of the first embodiment explained using FIGS. 1 and 2.

The arbiter 310 of the embodiment determines a number of continuous access upper limit times based on a weighted value in response to an access request from an internal bus 305 based on data amounts from three FiFos 0 to 2. More specifically, when the three FiFos 0 to 2 have larger data amounts, the arbiter 310 determine a larger value to the number of continuous access upper limit times. As an example, when the data amount of data stored in a FiFo becomes a state of FULL, the arbiter 310 determines the number of continuous access upper limit times as a value twice as large as a number of times based on a weighted value.

After an access is performed as many times as the number of continuous access upper limit times, the arbiter 310 changes a priority order of data output from the three FiFos 0 to 2. The arbiter 310 selects a FiFo memory from which data is transferred to an external bus according to the changed priority order and outputs the data stored in the select FiFo memory to the external bus.

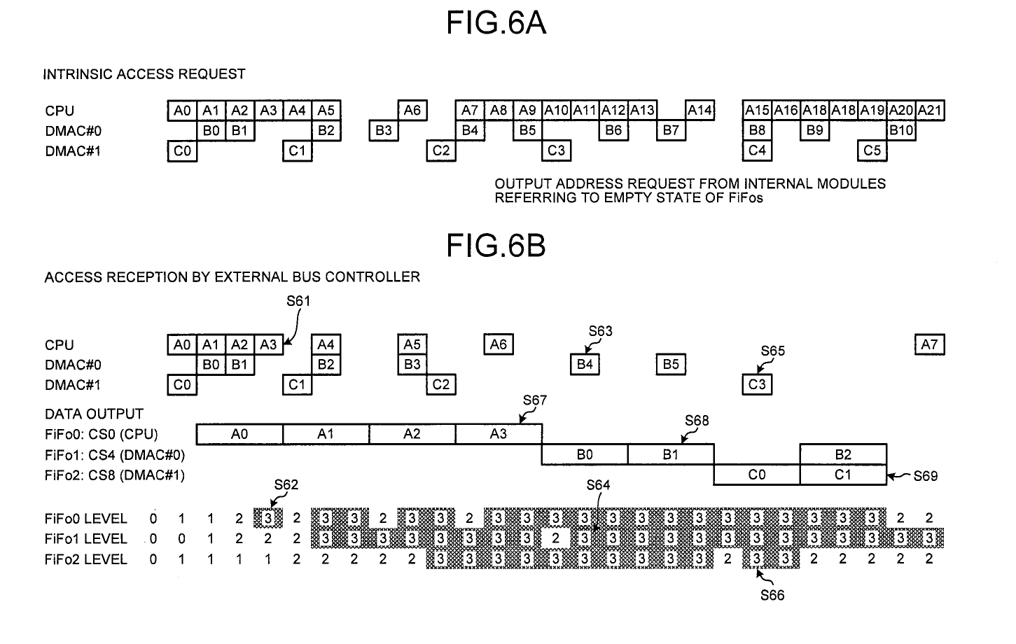

FIGS. 6A and 6B are explanatory views illustrating operation timings of an external bus controller of the third embodiment. FIG. 6A illustrates access request timings from respective modules and are the same as those of FIG. 4A. FIG. 6B illustrates access timings when the arbiter 310 of the embodiment interchanges priority orders of respective accesses based on a weighted value. Also in the example, the FiFos 0 to 2 use three-stage memories, and shaded portions of FiFo levels illustrate a state that the FiFo becomes FULL.

In the example of FIG. 6B, a weighted value of the FiFo 0 is set to 2, a weighted value of the FiFo 1 is set to 1.5, and a weighted value of the FiFo 2 is set to 1 likewise FIG. 5B as the example of the second embodiment. However, in the arbiter 310 of the embodiment, further, switching timings are changed according to data amounts of the FiFos 0 to 2.

In the embodiment, when a FiFo memory is in the state of FULL as a data amount of the FiFo memory, the arbiter 310 switches the priority order using a value twice as large as a weighted value as an upper limit value of a continuous access. In the example of FIG. 5B, in, for example, the FiFo 0, a weighted value 2×2=four times is set as the upper limit value of the continuous access. Note that the calculation method of the upper limit value of the continuous access is not limited to the above method.

The setting of the weighted value according to the data amount is preferably changed according to a data access frequency of a system. Note that although there is a method of fixing the priority order while a FiFo memory becomes FULL, when an access having a high frequency such as a burst access for reading/writing data from and to continuous addresses, the FiFo memory becomes the state of FULL at all times and thus there is a possibility that an access to other space is disrupted. Accordingly, the priority order is switched by setting the upper limit of the continuous access as in the embodiment.

The priority order is specifically changed by the weighted value based on the data amount as described below. Ordinarily, although the arbiter 310 continuously applies a highest priority order of the FiFo 0 having the weighted value of 2 in an access performed twice, when an access request to A3 is received from a CPU (S61) as illustrated in of FIG. 6B, a level of the FiFo 0 becomes 3 and the FiFo 0 becomes the state of FULL (S62).

Accordingly, the arbiter 310 sets the upper limit value of the continuous access to four times which is twice as large as the weighted value 2, applies a priority order of FiFo 0>FiFo 1>FiFo 2 in an access performed four times as illustrated in FIG. 6B, selects the FiFo 0 according to the priority order, and outputs the data stored in the selected FiFo 0 to the external bus (S67). With the operation, since the upper limit value of the continuous access is reached, the arbiter 310 changes the priority order in a next access.

Accordingly, as illustrated in FIG. 6B, in a first access, “A0” stored in the FiFo 0 is output to the external bus, in a second access, “A1” stored in the FiFo 0 is output to the external bus, in a third access, “A2” stored in the FiFo 0 is output to the external bus, and in a fourth access, “A3” stored in the FiFo 0 is output to the external bus.

In a next access, the arbiter 310 changes the priority order to FiFo 1 having weighted value of 1.5 and highest priority order>FiFo 2>FiFo 0. Ordinarily, the arbiter 310 applies a highest priority order of the FiFo 1 having the weighted value of 1.5 to an access performed only once, when an access request to B4 is received from a DMAC #0 (S63) and B4 is stored in the FiFo 1 as illustrated in of FIG. 6B, a level of the FiFo 1 becomes 3 and the FiFo 1 becomes the state of FULL (S64).

Accordingly, the arbiter 310 sets the upper limit value of the continuous access to twice that is twice as large as a number of times of 1 according to the weighted value of 1.5, and, as illustrated in FIG. 6B, in the access performed twice, the arbiter 310 applies a priority order of FiFo 1>FiFo 2>FiFo 0, selects the FiFo 1 according to the priority order, and outputs the data stored in the selected FiFo 1 to the external bus (S68). With the operation, since the upper limit value of the continuous access is reached, the arbiter 310 changes the priority order in a next access.

Accordingly, as illustrated in FIG. 6B, in a fifth access, “B0” stored in the FiFo 1 is output to the external bus, and in a sixth access, “B1” stored in the FiFo 1 is output to the external bus.

Note that, at a second round, the arbiter 310 sets the upper limit value of the continuous access to four times that is twice as large as a number of times of 2 according to the weighted value of 1.5.

In a next access, the arbiter 310 changes the priority order to FiFo 2 having weighted value of 1 and highest priority order>FiFo 0>FiFo 1. Ordinarily, the arbiter 310 applies a highest priority order of the FiFo 2 having the weighted value of 1 to an access performed only once, as illustrated in FIG. 6B, when an access request to C3 is received from the DMAC #0 (S65) and C3 is stored in the FiFo 2, a level of the FiFo 2 becomes 3 and the FiFo 2 becomes the state of FULL (S66).

Accordingly, the arbiter 310 sets the upper limit value of the continuous access to twice that is twice as large as a number of times of 1 according to the weighted value of 1, and, as illustrated in FIG. 6B, in the access performed twice, the arbiter 310 applies a priority order of FiFo 2>FiFo 0>FiFo 1, selects the FiFo 2 according to the priority order, and outputs the data stored in the selected FiFo 2 to the external bus (S69). With the operation, since the upper limit value of the continuous access is reached, the arbiter 310 changes the priority order in a next access.

Accordingly, as illustrated in FIG. 6B, in a seventh access, “C0” stored in the FiFo 2 is output to the external bus, and in an eighth access, “C1” stored in the FiFo 2 is output to the external bus.

As described above, in the embodiment, the arbiter 310 determines the number of continuous access upper limit times based on the weighted values to an access request from the internal bus 305 based on the data amounts of the three FiFos 0 to 2, and after an access is performed as many times as the number of continuous access upper limit times, the arbiter 310 changes the priority order of data output from the three FiFos 0 to 2. As a result, since data of respective bus masters are uniformly transferred while preferentially executing a process having a high access frequency, a lock time of the internal bus can be shortened, and thereby a performance can be improved.

Note that the arbiter 310 of the first to third embodiments may be realized by executing a program by a CPU in addition to that the arbiter 310 is composed of hardware.

According to the embodiments when write accesses are performed from plural internal modules to different external bus spaces at the same time, there is achieved an effect that a frequency at which the internal bus is waited can be reduced and a performance of the internal bus can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An access control apparatus comprising:
an external bus control unit that controls an external bus for transmitting and receiving data to and from an external device, wherein the external bus control unit comprises:
a plurality of storage units disposed corresponding to the external device for temporarily storing data from an internal bus; and
an arbitration unit that selects a storage unit for transferring data to the external bus from the plurality of storage units in response to an access request from the internal bus and outputs the data stored in the selected storage unit to the external bus.

2. The access control apparatus according to claim 1, wherein the arbitration unit changes a priority order of the data output from the plurality of storage units in response to an access request from the internal bus and selects the storage unit for transferring data to the external bus according to the changed priority order.

3. The access control apparatus according to claim 2, wherein:
each of the plurality of storage units is previously set with a weighted value; and
the arbitration unit changes a priority order of data output from each of the plurality of storage units based on the weighted value in response to an access request from the internal bus.

4. The access control apparatus according to claim 3, wherein when a storage unit has a larger weighted value, the storage unit sets a larger number of access times to which a highest priority order of the storage unit is applied, and after the priority order is applied as many times as the access number of times, the arbitration unit changes the priority order.

5. The access control apparatus according to claim 2, wherein the arbitration unit determines a number of continuous access upper limit times based on the weighted value in response to an access request from the internal bus based on a data amount of each of the plurality of storage units, and after an access is performed as many times as the number of continuous access upper limit times, the arbitration unit changes a priority order of data output from the plurality of storage units.

6. The access control apparatus according to claim 5, wherein when the data amount is larger, the arbitration unit determines the number of continuous access upper limit times having a larger value.

7. The access control apparatus according to claim 6, wherein when the data amount of data stored in the storage unit becomes a state of FULL, the arbitration unit determines the number of continuous access upper limit times as twice as many as a number of times based on the weighted value.

8. The access control apparatus according to claim 6, wherein the storage unit is a first-in/first-out FiFo memory.

9. An image forming apparatus comprising a control unit that performs control as to an image formation, wherein:
the control unit comprises an external bus control unit that controls an external bus for transmitting and receiving data to and from an external device that is a device externally of the control unit; and
the external bus control unit comprises:
a plurality of storage units disposed corresponding to the external device for temporarily storing data from the internal bus; and
an arbitration unit that performs control for changing an order in which data of each of the plurality of storage units is output to the external bus each time an access is performed from the internal bus and outputs data of each of the plurality of storage units to the external bus in the changed order.

10. An access control method performed in an access control apparatus, wherein:
the access control apparatus comprises an external bus control unit that controls an external bus for transmitting and receiving data to and from an external device; and
the external bus control unit comprises a plurality of storage units disposed corresponding to the external device for temporarily storing data from an internal bus, and
the access control method comprising:
performing control for changing an order in which data of each of the plurality of storage units is output to the external bus each time an access is performed from the internal bus; and
outputting data of each of the plurality of storage units to the external bus in the changed order.
